(19) United States
(12) Patent Application Publication
(10) Pub. No.: US 2025/0077158 A1
(43) Pub. Date: Mar. 6, 2025

(54) Method of Setting a Display Mode with One Click through the Display Buttons

(71) Applicant: QISDA CORPORATION, Taoyuan City (TW)

(72) Inventor: Yu-Fu Fan, Taoyuan City (TW)

(73) Assignee: QISDA CORPORATION, Taoyuan City (TW)

(21) Appl. No.: 18/797,500

(22) Filed: Aug. 7, 2024

(30) Foreign Application Priority Data
Sep. 1, 2023 (CN) 202311123736.3

(51) Int. Cl. G06F 3/14; G06F 8/61

(52) U.S. Cl. CPC G06F 3/1431; G06F 3/1454; G06F 8/61

(57) ABSTRACT

A method of setting a display mode includes installing an application on a device, the device including a first screen; triggering at least one button of a display, the display providing display information to the application installed on the device through a data channel protocol, the display including a second screen; and the application switching the device and the display to the display mode based on the display information.

### BACKGROUND OF THE INVENTION

### 1. Field of the Invention

A method of setting a display mode, in particular, a method of setting a display mode with one click through the display buttons.

### 2. Description of the Prior Art

When a display is connected through a cable such as a universal serial bus (USB), video graphics array (VGA), high definition multimedia interface (HDMI), display port (DP) or digital visual interface (DVI) to a computer. The computer can choose to switch to the desired display mode through the built-in buttons of Windows® or Mac®. The display mode includes duplicate mode, extend mode, first screen only mode, and second screen only mode. The conventional technology can only switch the mode from the computer. When the computer is connected to multiple monitors, the display mode of each monitor cannot be easily set, so it lacks flexibility and is not user friendly.

### SUMMARY OF THE INVENTION

An embodiment provides a method of setting a display mode including installing an application on a device, the device comprising a first screen; triggering at least one button of a display, the display providing display information to the application installed on the device through a data channel protocol, the display comprising a second screen; and the application switching the device and the display to the display mode based on the display information.

Another embodiment provides a method of setting a display mode including installing an application on a device, the device comprising a first screen; selecting a display mode of an on-screen display (OSD) of a display, the display providing display information to the application installed on the device through a data channel protocol, and including a second screen; and the application switching the device and the display to the display mode based on the display information.

Another embodiment provides a method of setting a display mode including installing an application on a device, the device comprising a first screen; and selecting a display mode through the application, the application switching the device and the display to the display mode, the display comprising a second screen.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of switching a display mode of the device through the buttons of the display according to an embodiment of the present invention.

FIG. 2 is a flow chart of a method for setting a display mode according to the embodiment of the present invention.

FIG. 3 is a flow chart of method for setting a display mode according to another embodiment of the present invention.

FIG. 4 is a flow chart of method for setting a display mode according to another embodiment of the present invention.

FIG. 5 is a schematic diagram when a first display and a second display are connected to the device at the same time according to an embodiment of the present invention.

### DETAILED DESCRIPTION

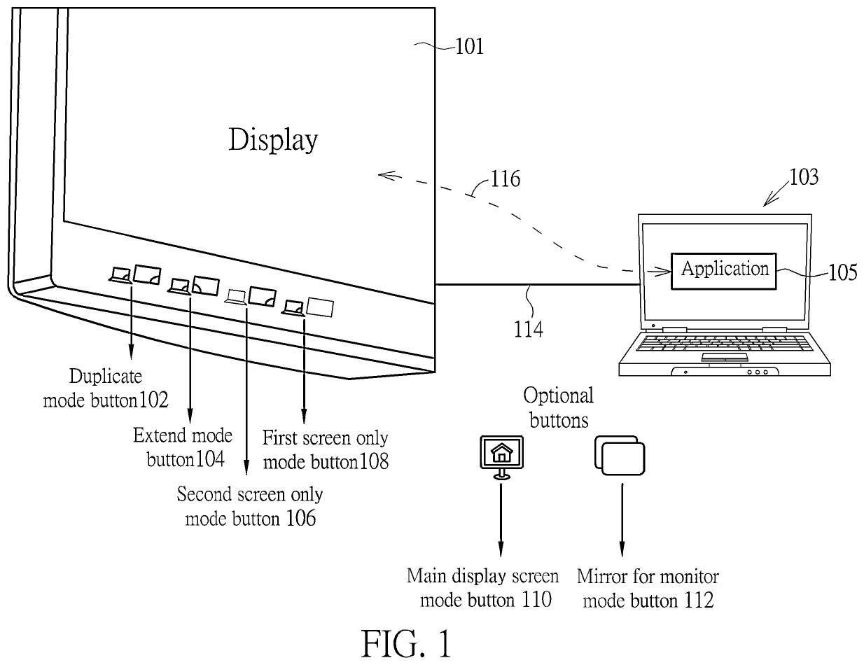

FIG. 1 is a schematic diagram of switching a display mode of the device 103 through the buttons of the display 101 according to an embodiment of the present invention. The display 101 is not limited to a general computer monitor, it may include a projector, a mobile communications display device, or an external display device coupled to a Windows® or Mac® operating system. An application program 105 is installed in the device 103. The device 103 can be a personal computer (PC), a notebook computer or a mobile device, and the application program 105 communicates with the display 101 through a data channel protocol. When a button or virtual button on the display 101 is triggered, the display information will be transmitted to the application 105 on the device 103 through the data channel protocol, and then the application will activate the display mode corresponding to the display information through the video cable 114. The display modes include a duplicate mode triggered by a duplicate mode button 102, an extend mode triggered by an extend mode button 104, a second screen only mode triggered by a second screen only mode button 106, a first screen only mode triggered by a first screen only mode button 108, a main display screen mode triggered by a main display screen mode button 110 in the extend mode, and a mirror for monitor mode triggered by a mirror for monitor mode button 112 in the duplicate mode.

In the duplicate mode, the screen of the device 103 and the screen of the display 101 will display the same image. In the extend mode, the screen of the device 103 and the screen of the display 101 can be displayed side by side, and the mouse can move freely between the two screens. The screen of the device 103 and the screen of the display 101 can be regarded as a wider screen. The window in the screen of the device 103 can be dragged to the display 101, and vice versa. In the second screen only mode, only the screen of the display 101 will be displayed, and the screen of the device 103 will be turned off. In the first screen only mode, only the screen of the device 103 will be displayed, and the screen of the display 101 will be turned off. When the main display screen button 110 in the extend mode is triggered, the main screen of the system will change from the device 103 as the main screen and the display 101 as the secondary screen to the device 103 as the secondary screen and the display 101 as the main screen, and vice versa when the main display screen button 110 in the extend mode is triggered again. This option can change the position of the operating system's toolbar, desktop tools, and system notifications so they are on the main screen. When the mirror for monitor mode button 112 in the duplicate mode is triggered (provided that the device 103 is an Apple® computer), the screen source of another device can be selected as the mirror content source in the duplicate mode.

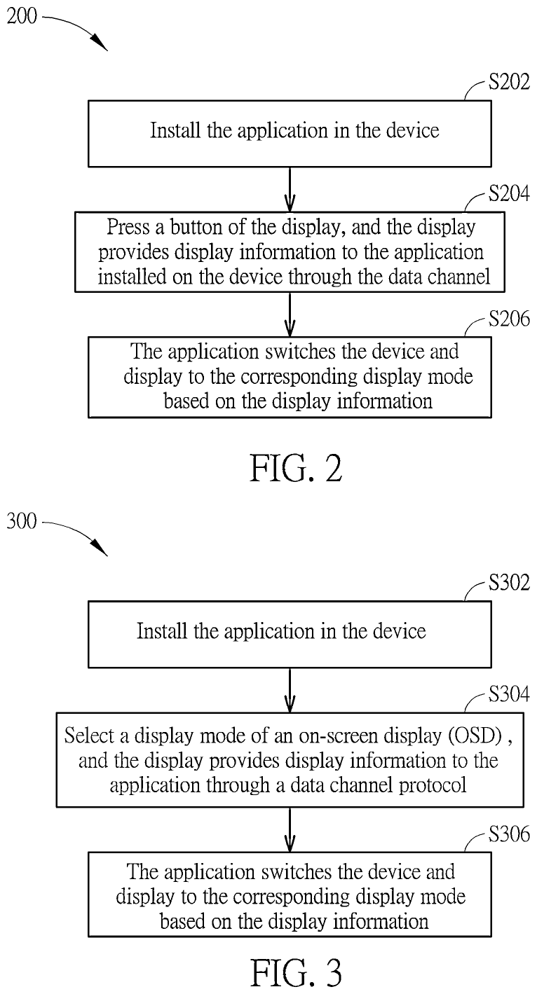

FIG. 2 is a flow chart of a method 200 for setting a display mode according to the embodiment of the present invention. The method 200 includes the following steps:
Step S202: Install the application 105 on the device 103, wherein the device 103 includes a first screen;
Step S204: Trigger a button of the display 101, and the display 101 provides display information to the application 105 installed on the device 103 through the data channel protocol 116, the display 101 includes a second screen; and
Step S206: The application 105 switches the device 103 and the display 101 to the corresponding display mode according to the display information.

In step S204, the display 101 may have the duplicate mode button 102, the extend mode button 104, the first screen only mode button 106, the second screen only mode button 108, the main display screen mode button 110 and/or the mirror for monitor mode button 112. The data channel protocol 116 can be a display data channel command interface (DDC/CI), which uses a universal serial bus (USB), video graphics array (VGA), high definition multimedia interface (HDMI), display port (DP) or digital visual interface (DVI) to transmit the display information.

In step S206, the display mode may be a duplicate mode, an extend mode, a first screen only mode or a second screen only mode. The extend mode may include a main display screen mode, which is used to switch the main display screen of the extend mode, and the main display screen mode may be based on cyclic switching. In addition, the duplicate mode may include a mirror for monitor mode, which may be used to determine the mirror source when the device is, for example, an Apple® computer.

FIG. 3 is a flow chart of method 300 for setting a display mode according to another embodiment of the present invention. The method 300 includes the following steps:
Step S302: Install the application 105 on the device 103, the device 103 includes a first screen;
Step S304: Select the display mode of the on-screen display (OSD) of the display 101, the display 101 provides display information to the application 105 installed on the device 103 through the data channel protocol 116, and includes a second screen; and
Step S306: The application 105 switches the device 103 and the display 101 to the corresponding display mode according to the display information.

In step S304, the display mode may be a duplicate mode, an extend mode, a first screen only mode or a second screen only mode. The extend mode may include a main display screen mode for switching the main display screen of the extend mode, and the main display screen mode may be based on cyclic switching. In addition, the duplicate mode includes a mirror for monitor mode, which can be used to determine the mirror image source when the device 103 is, for example, an Apple® computer. The data channel protocol 116 may be a display data channel command interface (DDC/CI), which uses universal serial bus (USB) or video graphics array (VGA), high definition multimedia interface (HDMI), display port (DP) or digital visual interface (DVI) to transmit display information.

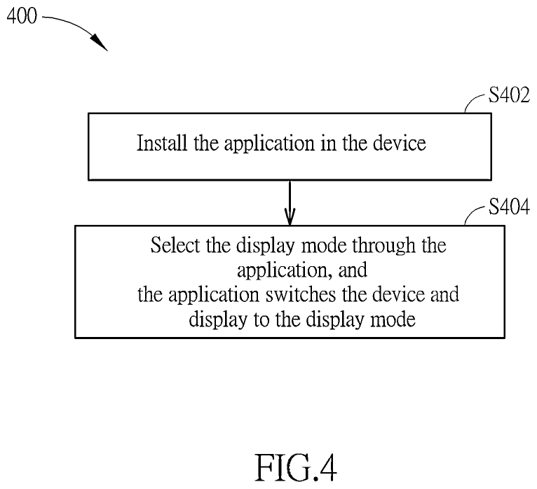

FIG. 4 is a flow chart of method 400 for setting a display mode according to another embodiment of the present invention. The method 400 includes the following steps:
Step S402: Install the application 105 on the device 103, the device 103 includes a first screen;
Step S404: Select the display mode through the application 105, and the application 105 switches the device 103 and the display 101 to the display mode, the display 101 includes a second screen.

In step S404, the display mode may be a duplicate mode, an extend mode, a first screen only mode or a second screen only mode. The extend mode includes a main display screen mode, which is used to switch the main display screen of the extend mode, and the main display screen mode can be based on cyclic switching. In addition, the duplicate mode includes a mirror for monitor mode, which can be used to determine the mirror image source when the device is an Apple® computer, for example.

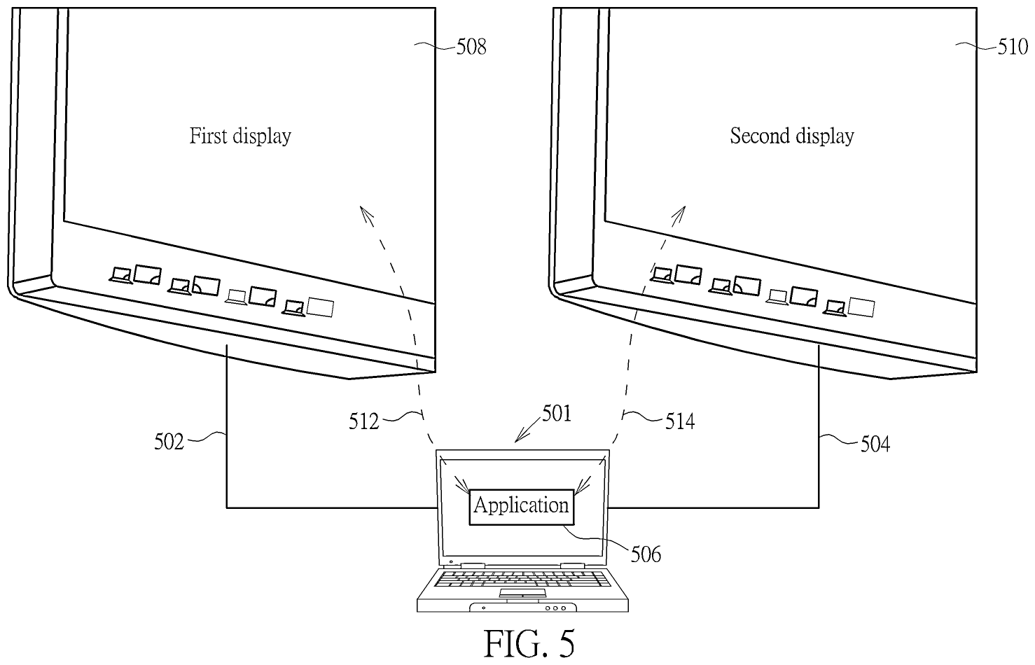

FIG. 5 is a schematic diagram when a first display 508 and a second display 510 are connected to the device 501 at the same time according to an embodiment of the present invention. An application 506 is installed in the device 501, and the first display 508 communicates with the application 506 through the first data channel 512 and the first video cable 502, and the second display 510 communicates with the application 506 through the second data channel 514 and the second video cable 502. When the button or virtual button on the first display 508 is triggered, the first display 508 will send the first display information to the application 506 through the first data channel 512, so that the application 506 can switch to the corresponding display mode (such as duplicate mode, extend mode, second screen only mode, first screen only mode) through the first video cable. When the button or virtual button on the second display 510 is triggered, the second display 510 will transmit the second display information to the application 506 through the second data channel 514, so that the application 506 can switch to the corresponding display mode (such as duplicate mode, extend mode, second screen only mode, first screen only mode) through the second video cable.

When the first display 508 switches to the duplicate mode, the screen of the device 501 and the screen of the first display 508 will display the same image. When the second display 510 switches to the duplicate mode, the screen of the device 501 and the screen of the second display 510 will display the same image. When both the first display 508 and the second display 510 are switched to the duplicate mode, the screen of the device 501 and the screens of the first display 508 and the second display 510 will display the same image.

When both the first display 508 and the second display 510 are switched to the extend mode, the screen of the device 501 can be displayed side by side with the screens of the first display 508 and the second display 510, and the mouse can move freely between the three screens. The screen of the device 501 and the screens of the first display 508 and the second display 510 can be regarded as a wider screen, and the window in the screen of the device 501 can be dragged to the first display 508 or the second display 510, and vice versa. The window in the screen of the first display 508 can also be dragged to the device 501 and the second display 510, and vice versa. The window in the screen of the second display 510 can also be dragged to the device 501 and the first display 508, and vice versa.

When the first display 508 switches to the second screen only mode, only the screen of the first display 508 is displayed, and the screen of the device 501 is turned off. When the second display 510 switches to the second screen only display mode, only the screen of the second display 510 is displayed, and the screen of the device 501 is turned off. When both the first display 508 and the second display 510 are switched to the second screen only mode, only the screens of the first display 508 and the second display 510 are displayed, and the screen of the device 501 is turned off.

When the first display 508 switches to the first screen only mode, only the screen of the device 501 is displayed, and the screen of the first display 508 is turned off. When the second display 510 switches to the first screen only mode, only the screen of the device 501 is displayed, and the screen of the second display 510 is turned off. When both the first display 508 and the second display 510 are switched to the first screen only mode, only the screen of the device 501 is displayed, and the screens of the first display 508 and the second display 510 are turned off.

In the extend mode, when the main display screen button 110 of the first display 508 or the second display 510 is triggered, the system will change from the device 501 with the main screen and the first display 508 and the second display 510 with the auxiliary screens to the device 501 and the second display 510 with auxiliary screens, and the first display 508 with the main screen. When the main display screen button 110 of the first display 508 or the second display 510 is triggered again, the system will change from the first display 508 with the main screen and the device 501 and the second display 510 with the auxiliary screens to the device 501 and the first display 510 with the auxiliary screens and the second display 510 with the main screen. When the main display screen button 110 of the first display 508 or the second display 510 is triggered again, the system will change from the second display 510 with the main screen and the device 501 and the first display 508 with the auxiliary screens to the device 501 with the main screen and the first display 508 and the second display 510 with the auxiliary screens, thereby cyclically changing the main screen of the system. This option will affect the position of the toolbar of the operating system, which will be located on the main screen. When the mirror for monitor mode button 112 in the duplicate mode is triggered (provided that the device 501 is an Apple® computer), the screen source of another device can be selected as the mirror content source in the duplicate mode.

In conclusion, the present invention implements a method of switching display systems using physical or virtual buttons on the display by installing an application on the device and communicating with the display using a data channel protocol, thereby enhancing the convenience and management of using the display.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of setting a display mode, comprising:
installing an application on a device, the device comprising a first screen;
triggering at least one button of a display, the display providing display information to the application installed on the device through a data channel protocol, the display comprising a second screen; and
the application switching the device and the display to the display mode based on the display information.

2. The method of claim 1, wherein the button is a duplicate mode button, an extend mode button, a first screen only mode button, a second screen only mode button, a main display screen mode button, or a mirror for monitor mode button.

3. The method of claim 1, wherein the display mode is a duplicate mode, an extend mode, a first screen only mode, or a second screen only mode.

4. The method of claim 3, wherein the extend mode comprises a main display screen mode, configured to switch a main display screen of the extend mode.

5. The method of claim 4, wherein the main display screen of the extend mode is switched cyclically in the main display screen mode.

6. The method of claim 3, wherein the duplicate mode comprises a mirror for monitor mode configured to select a mirror video source of the duplicate mode.

7. The method of claim 1, wherein the data channel protocol is a display data channel command interface (DDC/CI).

8. The method of claim 1, wherein the data channel protocol transmits data through a universal serial bus (USB), video graphics array (VGA), high definition multimedia interface (HDMI), display port (DP) or digital visual interface (DVI).

9. A method of setting a display mode, comprising:
installing an application on a device, the device comprising a first screen;
selecting a display mode of an on-screen display (OSD) of a display, the display providing display information to the application installed on the device through a data channel protocol, and including a second screen; and
the application switching the device and the display to the display mode based on the display information.

10. The method of claim 9, wherein the OSD is a duplicate mode button, an extend mode button, a first screen only mode button, a second screen only mode button, a main display screen mode button, or a mirror for monitor mode button.

11. The method of claim 9, wherein the display mode is a duplicate mode, an extend mode, a first screen only mode, or a second screen only mode.

12. The method of claim 11, wherein the extend mode comprises a main display screen mode, configured to switch a main display screen of the extend mode.

13. The method of claim 12, wherein the main display screen of the extend mode is switched cyclically in the main display screen mode.

14. The method of claim 11, wherein the duplicate mode comprises a mirror for monitor mode, configured to select a mirror video source of the duplicate mode.

15. The method of claim 9, wherein the data channel protocol is a display data channel command interface (DDC/CI).

16. The method of claim 9, wherein the data channel protocol transmits data through a universal serial bus (USB), video graphics array (VGA), high definition multimedia interface (HDMI), display port (DP) or digital visual interface (DVI).

17. A method of setting a display mode, comprising:
installing an application on a device, the device comprising a first screen;
selecting a display mode through the application, the application switching the device and the display to the display mode, the display comprising a second screen.

18. The method of claim 17, wherein the display mode is a duplicate mode, an extend mode, a first screen only mode, or a second screen only mode.

19. The method of claim 18, wherein the extend mode comprises a main display screen mode, configured to switch a main display screen of the extend mode.

20. The method of claim 18, wherein the duplicate mode comprises a mirror for monitor mode, configured to select a mirror video source of the duplicate mode.
